(19) United States
(12) Patent Application Publication
(10) Pub. No.: US 2010/0262492 A1
(43) Pub. Date: Oct. 14, 2010

(54) METHOD AND ARRANGEMENT RELATING TO A MEDIA STRUCTURE

(75) Inventors: Kent Bogestam, Hagersten (SE); Johan Hjelm, Tokyo (JP); George Philip Kongalath, Saint-Laurent, CA (US); Ignacio Mas Ivars, Tullinge (SE); Iftikhar Waheed, Stockholm (SE)

Correspondence Address: ROTHWELL, FIGG, ERNST & MANBECK, P.C., 1425 K STREET, N.W., SUITE 800, WASHINGTON, DC, 20005, US

(73) Assignee: TELEFONAKTIEBOLAGET L M ERICSSON (publ)

(21) Appl. No.: 12/679,760

(22) PCT Filed: Sep. 25, 2007
(86) PCT No.: PCT/SE07/50675

§ 371 Date: Jun. 18, 2010

(51) Int. Cl. H04N 7/025; G06Q 30/00

(52) U.S. Cl. 705/14.53; 725/34

(57) ABSTRACT

There is described a technique, executed in a node (600, 602, 604, 606, 620, 622, 632, 634) for transmitting, processing and/or producing media content, of providing a media structure (102, 204) for customising a main media content (100, 208). Said technique may comprise the steps of:
a. analysing said main media content (100, 208) regarding events of interest in said main media content (100, 208), and thereby identifying at least one event of interest,
b. based on the analysis performed in step a., storing descriptive information (108, 210), relating to said main media content (100, 208), in said media structure (102, 204).
   The technique comprises a method and an arrangement.

### TECHNICAL FIELD

The present invention relates to a method, executed in a node or a system for transmission and/or production of media content, of providing a media structure. The present invention also relates to an arrangement, in a node or system for transmission and/or production of media content, for providing a media structure.

### BACKGROUND

Today it is a problem to implement supplementary services in order to complement main media streams like e.g. TV-programmes and films. Such supplementary services may e.g. provide interactivity, service blending or image specific services. However, as mentioned before, until today there has not existed any suitable technique enabling the implementation of such services. One problem is that the main media stream often is encrypted which makes it difficult or impossible for other media providers to add supplementary services to the main media stream.

Standards such as MHP (Multimedia Home Platform) or SkyTv's proprietary interactivity features, embed actions that are pre-coded and closed which minimizes the possibility for operators, distributors or providers of new service offerings to seamlessly add additional content to a main media stream. Newly proposed standards such as MPEG-7 (MPEG=Moving Pictures Expert Group) or MHEG-5 (MHEG=Multimedia and Hypermedia information coding Expert Group) provide a lot of data about the main media stream but they still do not offer the possibility to easily add media information that is synchronized with the main media stream.

Another shortcoming of existing ways of transmitting media streams is the Quality of service (QoS). Quality of Service reserves bandwidth but does not preclude packet loss or degradation of the transmission channel. In the case of encrypted media streams packet loss is detected by the decoder or the decryption module and because of the packet loss the decoder is not able to decode the media stream, or the decryption module does not have the data block to prepare the media stream for the decoder.

In current solutions there is no mechanism to determine the degradation of the media stream en route or along the way to the decoder and end users have to endure heavy “coloured static blocks” or other unpleasant defects or artefacts in the media stream. Once the media stream leaves a streaming server there exist no simple mechanism to ensure that the packets needed to re-constitute the media stream have been received at a certain relay point between the streaming server and a decoder.

### SUMMARY

It is an object of the present invention to address the problems outlined above. This object and other objects can be obtained by providing methods and arrangements according to the independent claims attached below.

According to one aspect, a method, executed in a node for transmitting, processing and/or producing media content, of providing a media structure for customising a main media content is provided. Said method may comprise the steps of:

a. analysing said main media content regarding events of interest in said main media content and thereby identifying at least one event of interest,

b. based on the analysis performed in step a., storing descriptive information relating to said main media content in said media structure.

The method described herein may optionally have the following further characteristics.

According to another aspect, a method is provided which comprises the step of:

a. adding at least one synchronising reference, referring to said main media content, to said descriptive information.

According to a further aspect, a method is provided which comprises the step of:

a. adapting said media structure for containing media information, wherein such media information in particular may be: media content or references to media sources.

According to yet another aspect, a method is provided which comprises the step of:

a. adding media information to said media structure, and wherein said media information comprises referring information and/or additional information.

According to yet a further aspect, a method is provided which comprises the step:

a. defining said media structure as a system stream in a MPEG-2 Transport Stream.

According to another aspect, a method is provided which comprises the step of:

a. providing said at least one synchronising reference at least one of the following levels: a transport stream level, a transport stream packet level, a time stamp level, a slice level, a frame level, a macro block level, an object level.

According to a further aspect, a method is provided which comprises the step of:

a. adding to said referring information, at least one of the following: a pointer or link to the Internet, a pointer or link to a media source, a pointer or link to a particular action to be executed by a receiving device, data to be consumed by another media content than the main media content.

According to yet a further aspect, a method is provided which comprises the step of:

a. adding to said media information, at least one of the following: advertisement placement, content location functions, channel switching, content splicing, content related interactivity, voting services, marketing information, EPG (Electronic Program Guide), product placement, Picture in Picture services.

According to another aspect, a method is provided which comprises the step of:

a. linking said media information to said descriptive information.

According to yet another aspect, a method is provided which comprises the step of:

a. linking said media information to said at least one synchronising reference.

According to a further aspect, a method is provided which comprises the steps of:

a. analysing said main media content regarding events of interest in said main media content, and identifying at least one event of interest,

b. based on said at least one event of interest identified in step a., creating at least one synchronising reference and storing said at least one synchronising reference in said media structure, said at least one synchronising reference referring to said at least one event of interest.

According to yet a further aspect, a method is provided which comprises the steps of:

a. analysing said descriptive information,

b. adding media information to said media structure based on the analysis performed in step a.

According to another aspect, a method is provided which comprises the step of:

a. adding quantitative information, relating to said main media content, to said descriptive information, for enabling validation of the status of said main media content when transmitting said main media content and said media structure in a network or system. Said validation may be done by comparing the content of said main media content with said quantitative information.

According to yet another aspect, a method is provided which comprises the step of:

a. defining said main media content as a packetised stream and adding a list of the packets of said main media content to said quantitative information, said list comprising packet sequence numbers.

According to a further aspect, a method is provided which comprises the step of:

a. transmitting said main media content and said media structure as separate transport streams, for example as MPEG-2 Transport Streams.

According to yet a further aspect, a method is provided which comprises the step of:

a. transmitting said main media content and said media structure as one single transport stream, for example as one single MPEG-2 Transport Stream.

According to another aspect, an arrangement in a node for transmitting, processing and/or producing media content, for providing a media structure for customising a main media content, is provided. The arrangement may comprise:
a first element adapted to analyse said main media content regarding events of interest in said main media content, and to thereby identify at least one such event of interest,
a second element connected to receive at least one analysis result from said first element, and adapted to store descriptive information relating to said main media content. Said second element is adapted to store said descriptive information in said media structure, based at least partly on said at least one event of interest.

The arrangement described herein may optionally have the following further characteristics.

According to yet another aspect, an arrangement is provided wherein said second element is adapted to add at least one synchronising reference, referring to said main media content, to said descriptive information.

According to a further aspect, an arrangement is provided wherein said second element is adapted to adapt said media structure for containing media information. Wherein such media information in particular may be: media content or references to media sources.

According to yet a further aspect, an arrangement is provided wherein said second element is adapted to add media information to said media structure, and wherein said media information comprises referring information and/or additional information.

According to another aspect, an arrangement is provided wherein the arrangement comprises:
a third element for defining said media structure as a system stream in a MPEG-2 Transport Stream.

According to yet another aspect, an arrangement is provided wherein said second element is adapted to provide said at least one synchronising reference at least one of the following levels: a transport stream level, a transport stream packet level, a time stamp level, a slice level, a frame level, a macro block level, an object level.

According to a further aspect, an arrangement is provided wherein said second element is adapted to add at least one of the items from the following list, to said referring information: a pointer or link to the Internet, a pointer or link to a media source, a pointer or link to a particular action to be executed by a receiving device, data to be consumed by another media content than the main media content.

According to yet a further aspect, an arrangement is provided wherein said second element is adapted to add at least one of the items from the following list, to said media information: advertisement placement, content location functions, channel switching, content splicing, content related interactivity, voting services, marketing information, EPG (Electronic Program Guide), product placement, Picture in Picture services.

According to another aspect, an arrangement is provided wherein said second element is adapted to link said media information to said descriptive information.

According to yet another aspect, an arrangement is provided wherein said second element is adapted to link said media information to said at least one synchronising reference.

According to a further aspect, an arrangement is provided wherein said second element is adapted to create at least one synchronising reference and to store said at least one synchronising reference in said media structure. Said second element is adapted to store said at least one synchronising reference based at least partly on said at least one event of interest. Said at least one synchronising reference is referring to said at least one event of interest.

According to yet a further aspect, an arrangement is provided wherein said second element is adapted to analyse said descriptive information, and to add media information to said media structure. Furthermore, said second element is adapted to add media information to said media structure taking into account an analysis of said descriptive information.

According to another aspect, an arrangement is provided wherein said second element is adapted to add quantitative information, relating to said main media content, to said descriptive information. This is done to enable validation of the status of said main media content when transmitting said main media content and said media structure in a network or system. Said validation may be done by comparing the content of said main media content with said quantitative information.

According to yet another aspect, an arrangement is provided wherein said second element is adapted to define said main media content as a packetised stream and adapted to add a list of the packets of said main media content to said quantitative information. Said list may comprise at least one main media content packet index.

According to a further aspect, an arrangement is provided wherein the arrangement comprises a fourth element adapted to transmit said main media content and said media structure.

According to yet a further aspect, an arrangement is provided wherein said fourth element is adapted to transmit said main media content and said media structure as separate transport streams, for example as MPEG-2 Transport Streams.

According to another aspect, an arrangement is provided wherein said fourth element is adapted to transmit said main media content and said media structure as one single transport stream, for example as one single MPEG-2 Transport Stream.

### BRIEF DESCRIPTION OF THE DRAWINGS

The invention will now be described by way of non limiting embodiments with reference to the accompanying drawings in which:

FIG. 1 is a drawing illustrating the principle of the technique described herein,

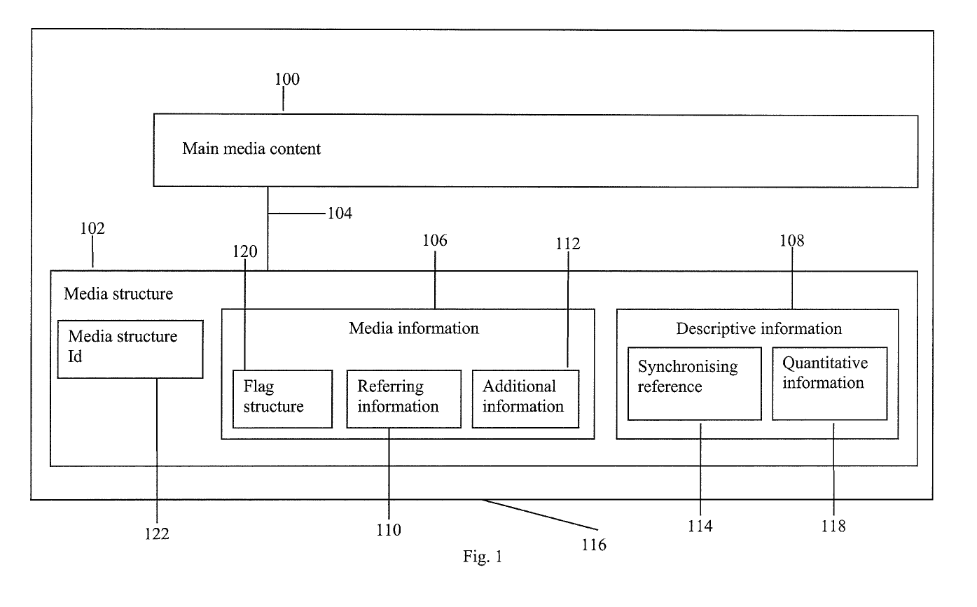

FIG. 2 is a drawing illustrating one possible implementation of the technique described herein in case of a main media stream 208 transported with the MPEG-2 TS,

FIGS. 3a-3c are drawings illustrating details about the implementation shown in FIG. 2,

FIG. 4a is a drawing showing one implementation of a link between the main media content 100, 208 and the media structure 102, 204,

FIG. 4b is a drawing illustrating a list 420 comprised in the descriptive information 108, 210. In this embodiment the list 420 comprises the packet sequence numbers (illustrated with reference signs 430-480) of the packets comprised in a main media stream 208.

FIG. 5a is a drawing showing method steps relating to the creation of descriptive information 108, 210,

FIG. 5b is a drawing showing method steps relating to the creation of media information 106, 212,

FIGS. 6a and 6b schematically show different possibilities regarding transmission of the main media content (100, 208) and the media structure (102, 204).

FIG. 7 is a drawing showing one example of an arrangement according to the technique described herein, the arrangement comprising first to fourth elements.

### DETAILED DESCRIPTION

Before the method and arrangement described herein is described in detail, it is to be understood that this method and arrangement is not limited to the particular component parts of the arrangements described or process steps of the methods described as such arrangements and methods may vary. It is also to be understood that the terminology used herein is for purposes of describing particular embodiments only, and is not intended to be limiting. It must be noted that, as used in the specification and the appended claims, the singular forms “a,” “an” and “the” also include plural referents unless the context clearly dictates otherwise. Thus, for example, reference to “an element” includes more than one such element, and the like.

In this specification and in the claims which follow, reference will be made to a number of terms which shall be defined to have the following meanings:

The term “about” is used to indicate a deviation of +/−2% of the given value, preferably +/−5% and most preferably +/−10% of the numeric values, when applicable.

The technique described herein may be used in nodes for the transmission and/or production and/or processing of media content. A node as described herein may be a node in a logical sense as well in a traditional sense. That is, a node that forms part of a system or network and may be connected or connectable to other nodes by communication means (by wire or wireless) or by means like physical delivery of items (e.g. normal mail). Non-limiting examples of nodes are: transmission and/or production and/or processing nodes, check and/or relay points, receiving devices, displaying devices, in systems for transmission and/or production and/or processing of media content. A production and/or processing node may e.g. be a site, studio or facility for the production and/or processing of media content. Non-limiting examples of systems are: terrestrial (over-the-air) broadcast systems, cable broadcast systems, direct broadcast satellite TV-systems, production or processing systems for media content, Internet, mobile communication systems, and combinations of such systems.

The technique described herein may generally also be used in systems for the transmission, production and/or processing of media content. Non-limiting examples of such systems are: terrestrial (over-the-air) broadcast systems, cable broadcast systems, direct broadcast satellite TV-systems, production or processing systems or facilities for media content, Internet, mobile communication systems, and combinations of such systems.

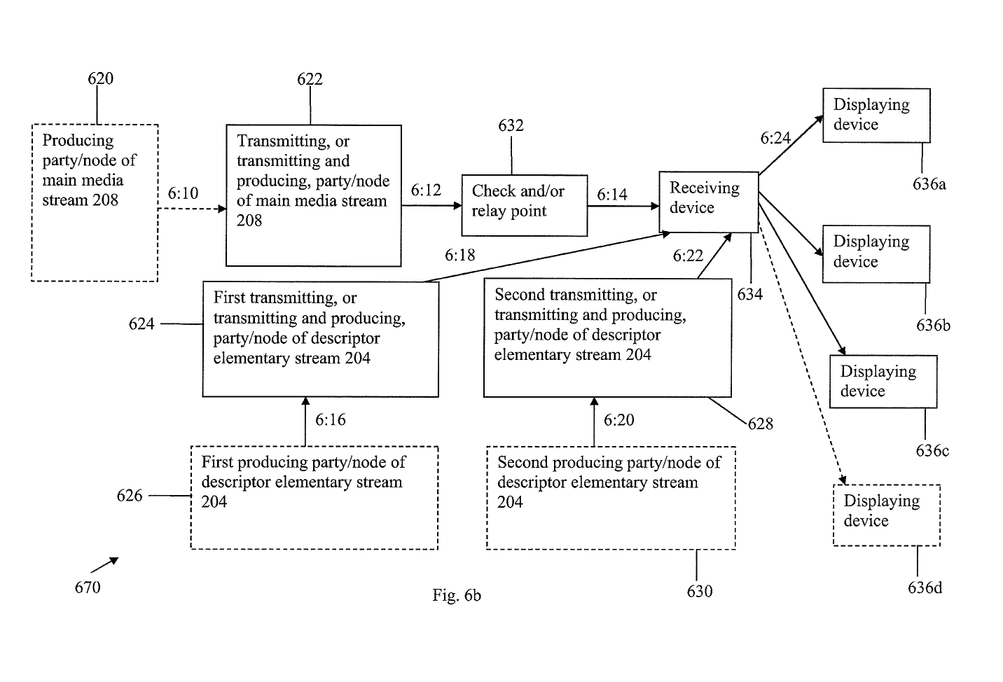

FIGS. 6a and 6b show examples of principal layouts of systems with examples of nodes (nodes in the sense described herein) that may be present in such systems. FIGS. 6a and 6b will be described more in detail later.

The technique described herein includes a media structure 102, 204 that is linked to a main media content 100, 208, e.g. a TV-program or a main media content 100, 208 stored on a storage medium, e.g. a Digital Video Disc (DVD), hard disk, flash memory or some other storage medium. The main media content (100, 208) may e.g. be transmitted in real time or in advance, before the point of time or moment of viewing. The media structure 102, 204 comprises descriptive information 108, 210 describing the content of the main media content 100, 208. The descriptive information 108, 210 may for example contain information stating that after a certain point in time after the beginning of the main media content 100, 208 there is displayed a certain object in a certain frame of the main media content 100, 208. It may also be possible to specify in which part (in which macro block e.g.) of the displayed frame or picture a certain object is displayed. Moreover, the media structure 102, 204 has the possibility to contain media information 106, 212 that may be displayed in or added to the main media content 100, 208 based on the descriptive information 108, 210. The media information 106, 212 may comprise two types of information, referring information 110, 214 and additional information 112, 216. The referring information 110, 214 may refer to external sources of media content that may be displayed in or added to the main media content 100, 208. Such referring information 110, 214 may e.g. be a reference or pointer to an Internet page or Internet site, a reference to a source of media content other than the source of the main media content 100, 208 (where such media content e.g. may be advertising). Additional information 112, 216 is media content that is comprised or stored in the media structure 102, 204 and which may be displayed in or added to the main media content 100, 208. The term media information is hereafter used as an generic term for the additional information 112, 216 and the referring information 110, 214. The media structure 102, 204 also comprises a media structure Id 122, 222 which identifies a certain media structure 102, 204 and is useful e.g. for routing a media structure 102, 204. Hence, the described media structure 102, 204 is an interface to the main media content 100, 208, where the media structure 102, 204 enables the synchronized addition of virtually any kind of media information 106, 212 or media content to the main media content 100, 208. The media information 106, 212 or media content may as mentioned e.g. be media content from the Internet or media content from media providers other than the provider of the main media content 100, 208, or as well media content from the provider of the main media content 100, 208. The media information 106, 212 or media content may e.g. comprise advertisement placement, content location functions, channel switching, content splicing, content related interactivity, voting services, marketing information, EPG (Electronic Program Guide), product placement or Picture in Picture services.

The term content splicing refers to a situation where one media stream is spliced into, or overlapped on, another media stream. For example may an additional media content be spliced into a main media content 100, 208.

Content location functions are functions that use information about the physical location of a set top box or receiving device or viewer to adapt the displayed media content. In this context one may adapt the media information 106, 212 that is presented or displayed to the viewer.

The media structure 102, 204 may be non-encrypted and since it contains descriptive information 108, 210 about a (possibly) encrypted main media content 100, 208 it is possible for other (other than the provider of the main media content 100, 208) media providers to add media information 106, 212 or additional media content to an encrypted main media content 100, 208.

Since the media structure 102, 204 contains descriptive information 108, 210 about the main media content 100, 208 it is possible to detect (at the receiving device or decoder and/or at various relay points in the distribution network) which information that has been lost in case of packet loss or other forms of degradation of the main media content 100, 208. It is then possible to send feedback to the source of the main media content 100, 208 and initiate some kind of forward error correction method and/or to choose alternative routes to ensure that the receiving device, e.g. the decoder of an end user, of the main media content 100, 208 receives complete data for decoding. The quality of the main media content 100, 208 may hence be validated at various points in the distribution network.

For media streams there exist a variety of different transport protocols, e.g. the MPEG-2 TS (MPEG=Moving Picture Experts Group, TS-Transport Stream) and the RTP (Real-time Transport Protocol). The RTSP (Real Time Streaming Protocol) is a protocol that can be used to control RTP streams and also MPEG-2 TS:s. The media structure 102, 204 described herein may be implemented to or in virtually any transport protocol but in the following the implementation in the case of a main media content 100, 208 transported with the MPEG-2 TS will be described more in detail. In this implementation the main media content 100, 208 will be called main media stream 208.

In the MPEG-2 TS there exists a system stream in addition to the audio and video streams. These three streams are all of the type Payload Elementary Stream. The audio stream together with the video stream is called the main media stream 208. The media structure 102, 204 described herein is implemented using the system stream. Hence, the media structure 102, 204 is implemented as a system stream. In the following the media structure 102, 204 is called descriptor elementary stream 204 in the MPEG-2 TS implementation. In the following the media structure Id 122 is called descriptor elementary stream Id (DESId) 222 in the MPEG-2 TS implementation. The descriptor elementary stream 204 is synchronized with the main media stream 208 and may be transmitted together with the main media stream 208 (in band) or separately from the main media stream 208 (out of band).

The descriptor elementary stream 204 comprises at least a description or system header 324, at least one synchronization reference 114, 218 and at least one field (that may be comprised in the media information 106, 212) comprising at least one reference, e.g. API (Application Program Interface) references, interactivity triggers or system triggers. One example of an interactivity trigger is a trigger that makes a message to be displayed on the screen or displaying device 608, 636. The message could contain information on how to vote on something displayed in the main media stream 208 for example. The synchronization references may be at the transport stream level, the packet level, the time stamp level, the slice level, the frame level, the macro block level, the object level or any other level possible to use. Time stamp means a point in time in the main media stream 208, counted from the start of the main media stream 208. Frame refers to the video elementary stream which is divided into frames of different types. There are I-frames, P-frames and B-frames (in the case of MPEG-2 encoding). The term slice refers to a set of frames, from one I-frame to another I-frame. The term macro block refers to the division of a frame into several macro blocks. Hence, the descriptor elementary stream 204 may contain synchronisation references 114, 218 of different resolution in time. Due to this feature it is possible to add media information 106, 212 with varying demands regarding the time resolution. Media information 106, 212 may be added to the main media stream 208 with varying precision or resolution in time thanks to different synchronisation references 114, 218. For certain media information 106, 212 it may for example be sufficient to add or activate the media information 106, 212 in correct relationship to a certain slice whereas for other media information 106, 212 it may be necessary or advantageous to be able to relate the media information 106, 212 to a specific macro block or object.

The media information 106, 212, comprising referring information 110, 214 (e.g. service interfaces) and additional information 112, 216 (e.g. data elements), may have one or more structures with flags within the structure, hereafter called flag structures 120, 224, e.g. to indicate at which point in the transmission path of the descriptor elementary stream 204 said flag structures 120, 24 may be removed from the descriptor elementary stream 204. Instead of being removed said flag structures 120, 224 may also be inactivated. Said flag structures 120, 224 do not have to originate at the encoder level (i.e. the level or point at which/where the descriptor elementary stream 204 is created) and may be added at any check or relay point in the transmission path of the descriptor elementary stream 204. Said flag structures 120, 224 may e.g. include flags that remove or inactivate information that is location or time dependent, e.g. triggers that trigger the display of a voting possibility for best player in a football match. Such a trigger should only be active when the football match is sent live. If a person watches a “taped” version of the match, e.g. from a VoD service, such a trigger should be removed or inactivated.

The descriptor elementary stream 204 may also include flag structures 120, 224 indicating which parts of the main media stream 208 that should be discarded as the first choice if the situation arises that parts of the main media stream 208 has to be discarded, e.g. due to problems with the transmission. Regarding frames, there may exist frames of different types in an encoding scheme like MPEG-2 for example. Self-encoded key frames are frames that are encoded and decoded only using information from the frame itself. Self-encoded key frames are called intraframes or I-frames in the MPEG-2 encoding scheme. Interceded frames are frames that are encoded and decoded using information from either the preceding frame (predictive, predicted or P-frames in the MPEG-2 encoding scheme), or from both the preceding and the following frames (bi-directional or B-frames in the MPEG-2 encoding scheme). It may for example be advantageous to discard interceded frames of the bi-directional type as the first choice since such a frame contains less information than frames of the predictive or intraframe type. Choosing between discarding frames of the predictive type or the intraframe type it would be better to discard frames of the predictive type.

Regarding structures that may be removed from the descriptor elementary stream 204: For example may an interactivity trigger in the descriptor elementary stream 204 be marked as active during a certain time interval (e.g. in real time) only and if the descriptor elementary stream 204 and hence the interactivity trigger is cached and streamed again, the interactive trigger may be stripped from the descriptor elementary stream 204. In the case that I-frame packet information is sent in the descriptor elementary stream 204, the I-frame packet information may be stripped at the access edge. To strip the I-frame packet information at the access edge may be advantageous if the bandwidth in the access link (the last part of the transmission path, connecting the receiving device) is a limiting factor and the receiving device 606, 634 does not use the I-frame packet information. If the bandwidth in the access link is a limiting factor also other information contained in the descriptor elementary stream 204 may be stripped at the access edge. It may be advantageous to in the first place strip such information which is not used by the receiving device 606, 634, or which is not important for the receiving device 606, 634 when processing the descriptor elementary stream 204.

The descriptor elementary stream 204 may comprise the following elements:

### 1. Descriptor Elementary Stream (DES) Identification, DESId 222

2. Size information relating to the main media stream 208 (e.g. the size of one or several frames in the main media stream, the size of a MPEG-2 TS packet or the size of the main media stream as a whole, just to mention a few examples).
3. Service flags
4. Synchronisation structure

4.1 PID (Program Identity Data) Reference

4.2 PES (Packetized Elementary Stream) Reference

4.3 PCR (Program Clock Reference) Reference

4.4 Slice Reference

4.5 Macro-Block Reference

4.6 Object Reference

5. Other media structures containing information about the main media stream 208.
6. Media information

The DESId identifies a certain descriptor elementary stream 204 and the DESId is useful e.g. for routing a descriptor elementary stream 204. The Size information may be comprised in the descriptive information 210. Service flags may be present both in the descriptive information 210 and in the media information 212.

The references listed at the points 4.1 to 4.6, under the heading 4. Synchronisation structure above, are hence such synchronisation references that may be comprised in the synchronisation reference 218 in the descriptive information 210.

The PID reference makes it possible to refer to a particular main media stream in a MPEG-2 TS, e.g. a Television program, without referring to any specific point in the main media stream. The synchronization reference 218 in the descriptive information 210 may hence comprise a PID reference referring to a main media stream 208 where the PID reference may be used to connect media information 212 to the main media stream 208 without having to specify any specific point in the main media stream 208 in connection with which the media information 212 should be activated. One example of how the PID reference may be used is for downloading an advertisement to the receiving device 604, 628 in advance. This may be done by providing referring information 110, 214 in the form of e.g. a trigger in the descriptor elementary stream 204 of a first main media stream 208. This trigger may then instruct the receiving device 604, 628 to download the content (e.g. advertisement) in or of a certain URL (Uniform Resource Locator) in the background, during a coming or subsequent main media stream 208 and to display said content directly after the coming or subsequent main media stream 208 has ended. In this way it is possible for the receiving device 604, 628 to choose when during the coming or subsequent main media stream 208 the advertisement should be downloaded in the background.

The PES reference makes it possible to refer to an individual stream in the MPEG-2 TS, for example the audio elementary stream 202. The PCR is a time stamp that may be used e.g. for synchronising media information 106, 212 with a certain point in time in the main media stream 208.

The Slice Reference makes it possible to refer to a certain slice in a media stream, the Macro-Block Reference makes it possible to refer to a certain macro-block in a media stream and the Object Reference makes it possible to refer to a certain object in a media stream.

The descriptor elementary stream 204 comprises descriptive information about the main media stream 208 it is associated to and the descriptive information 210 may e.g. include frame numbers, indication of the type of frame (e.g. self-encoded key frame, interceded frame), the packet identifiers that relate to specific locations in an I-frame or in other types of frames, hook information to associate trigger and/or advertisement placement during displaying of the main media stream 208.

The descriptor elementary stream 204 may carry one or more data blocks, comprised in the media information 212, that are synchronized to one or more position/s in the main media stream 208. One example of the content of such a data block could be a trigger saying ‘Go to this web page and download this content to be displayed in a small pop-up window’. Another possibility is that the content to be displayed in the pop-up window is stored directly in the data block, so that the receiving device 606, 634 (e.g. a set top box) reading or processing the descriptor elementary stream 204 does not need to go to the Internet to fetch the information to be displayed. The descriptor elementary stream 204 does not have to be maintained through the entire length or duration of the main media stream 208. For example may parts of the descriptor elementary stream 204 be discarded if they have become invalid or if bandwidth limitations makes it necessary to discard some information. The descriptor elementary stream 204 may also be present only for parts of the main media stream 208 for the reason that the descriptor elementary stream 204 is not needed for the entire duration of the main media stream 208. The device (e.g. the receiving device 604, 628) processing the descriptor elementary stream 204 acts on the descriptor elementary stream 204 only when it is present and is otherwise idle. The presence of the descriptor elementary stream 204 is optional and it may or may not contain compressed data blocks. Data segments in the descriptor elementary stream 204 may be encrypted using the main media stream 208 encryption methods and keys, or may have its own encryption algorithm and key structure.

The descriptor elementary stream 204 can be viewed as a data bearer that can be used to carry information about a program, frame or just a single elementary stream packet, that is to say that the descriptor elementary stream 204 can be used to describe the main media stream 208 at any desired granularity or level of detail depending on how the data in the descriptor elementary stream 204 is to be used by the various entities that may have access to the descriptor elementary stream 204.

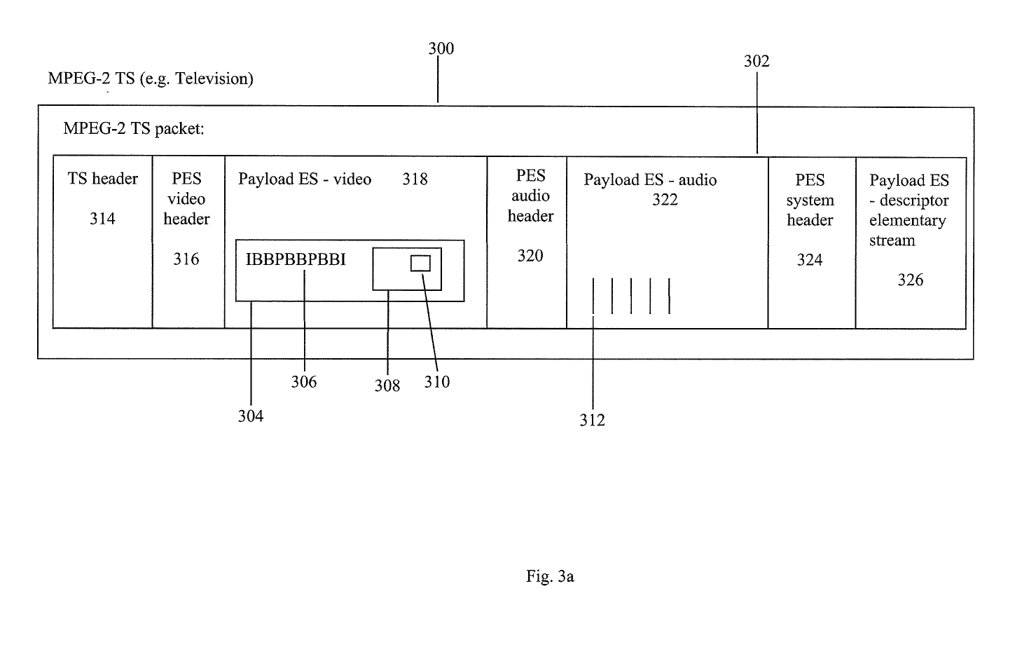

In FIGS. 3a-3c there is shown detailed views of a MPEG-2 TS. In FIG. 3a the MPEG-2 TS is shown as block 300. A MPEG-2 TS may e.g. be a TV-broadcast. A MPEG-2 TS comprises N (where N may be any rational number from 1 to infinity) MPEG-2 TS packets. In FIG. 3a one MPEG-2 TS package is shown as block 302. As shown in FIG. 3a each MPEG-2 TS package comprises a TS header 314, three Payload ES:s (Elementary Streams), in this implementation video elementary stream 318 having PES video header 316, audio elementary stream 322 having PES audio header 320 and the elementary stream 326 implemented as descriptor elementary stream 204 having PES system header 324. In FIG. 3a the different components of the video ES and the audio ES also are shown. In FIG. 3a 304 is a slice, 306 and 308 are frames, 310 is a macro block within a frame, in the video ES. Regarding the audio ES, 312 denotes one audio sample in the audio ES.

In FIG. 3b reference sign 350 denotes the different fields that may be comprised in a TS header and in FIG. 3c reference sign 360 denotes the different fields that may be comprised in a PES header. As mentioned before, e.g. a MPEG-2 TS 300 itself, a MPEG-2 TS package 302, a frame 306, 308, a macro block 310 or the audio information associated with a frame 306, 308 (wherein the audio information associated with a frame 306, 308 may comprise one or more audio samples 312) may be used as a synchronising reference 114, 218.

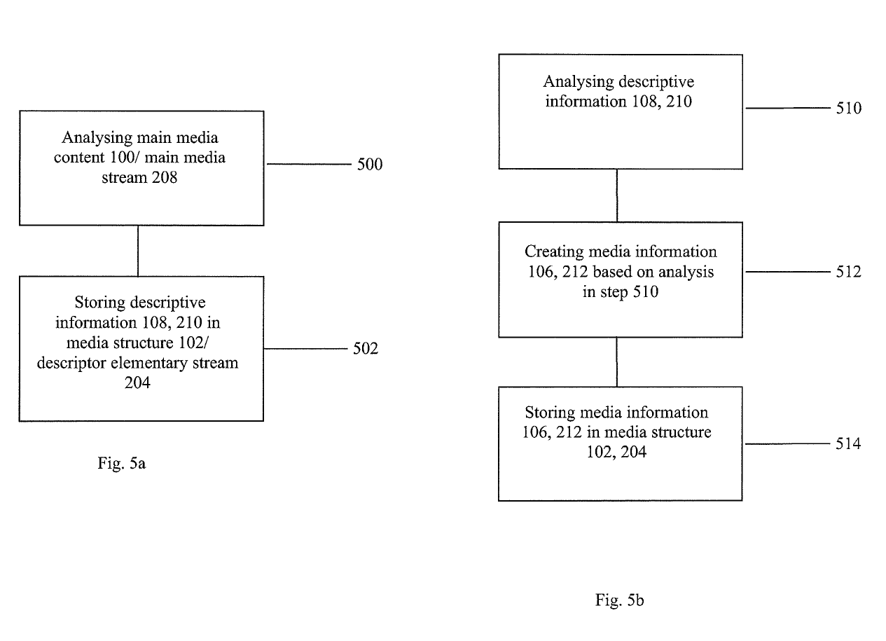

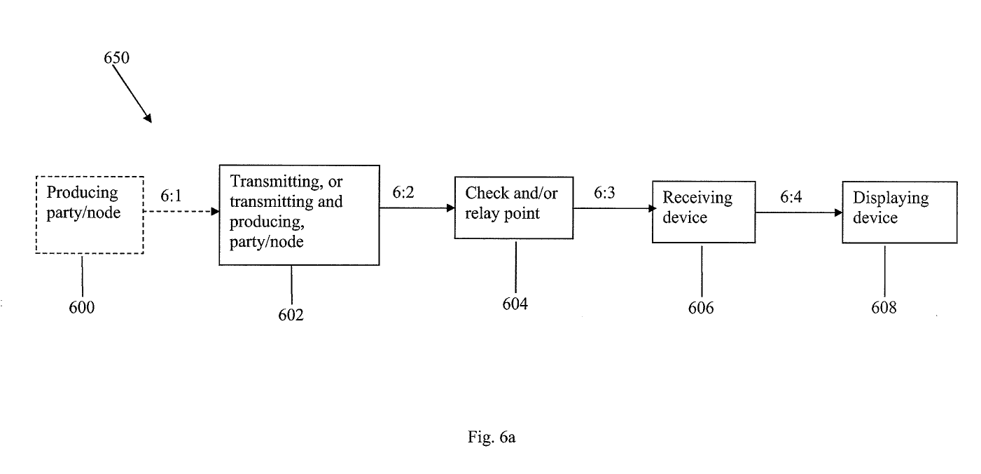

The forming or building of the descriptor elementary stream 204 is advantageously performed in two or more steps. First the descriptor elementary stream 204 is provided with descriptive information 108, 210 relating to the main media stream 208. This first step (schematically shown in FIG. 5a) is advantageously performed by the content provider, the provider of the content of the main media stream 208. This step may include at least one of the following sub steps (i) and ii)):

i) analysing the main media stream 208 and identifying interesting events (e.g. the display of certain objects) and their position in time and/or their location in the picture. This may e.g. also include identifying where in time different passages in the audio stream are presented. In this step it may also be analysed how many packets the main media stream 208 comprises and other characteristics regarding the structure of the main media stream 208, e.g. in which sequence the frames are (e.g. IBBPBBPBBI as one possible sequence in the case of a MPEG-2 encoded stream).

ii) storing descriptive information 108, 210, retrieved in the analysing step i), in the descriptor elementary stream 204, as synchronising reference 114, 218 and/or quantitative information 118, 220.

The second step (schematically shown in FIG. 5b) in forming or building the descriptor elementary stream 204 may be performed as one step or may be divided in several steps. If divided in several steps the second step may be performed by one or several different entities, e.g. operators or service providers. In this second step the descriptor elementary stream 204 is provided with media information 106, 212, linked to the events identified in the first step. Such media information 106, 212 may e.g. be advertising, information, interactive content, location dependent content, links or pointers to such content, links to the Internet, links to other services. One example of media information 106, 212 is data to be consumed by programs running in parallel with a TV application/TV program. Using the technique described herein it may e.g. be possible to watch a football match and at the same time have a small window with a representation of the complete football field and dots representing all the players on the field in order to know where on the field each and every player is located.

These first and second steps may be performed or executed in a system 650, 670 for transmitting and/or producing media content, either manually or by using suitable algorithms.

### Transmission of the Descriptor Elementary Stream

The descriptor elementary stream 204 may be distributed or transmitted in various ways. One possibility is to distribute it together with the main media stream 208 (in band). In the case of using the MPEG-2 TS it means that in each MPEG-2 TS packet at least a part of the descriptor elementary stream 204 will be present. In this case the descriptor elementary stream 204 is divided into packets of a size appropriate for the space available for the system stream in one MPEG-2 TS packet. The packets of the descriptor elementary stream 204 are then put into a MPEG-2 TS packet, into the space available for the system stream. The descriptor elementary stream 204 is hence packetised in different MPEG-2 TS packets, in the same way as the audio and video streams are packetised. To distribute the descriptor elementary stream 204 together with the main media stream 208 (in band) may be an advantage since it requires less functionality in the device or node processing the descriptor elementary stream 204 and the main media stream 208.

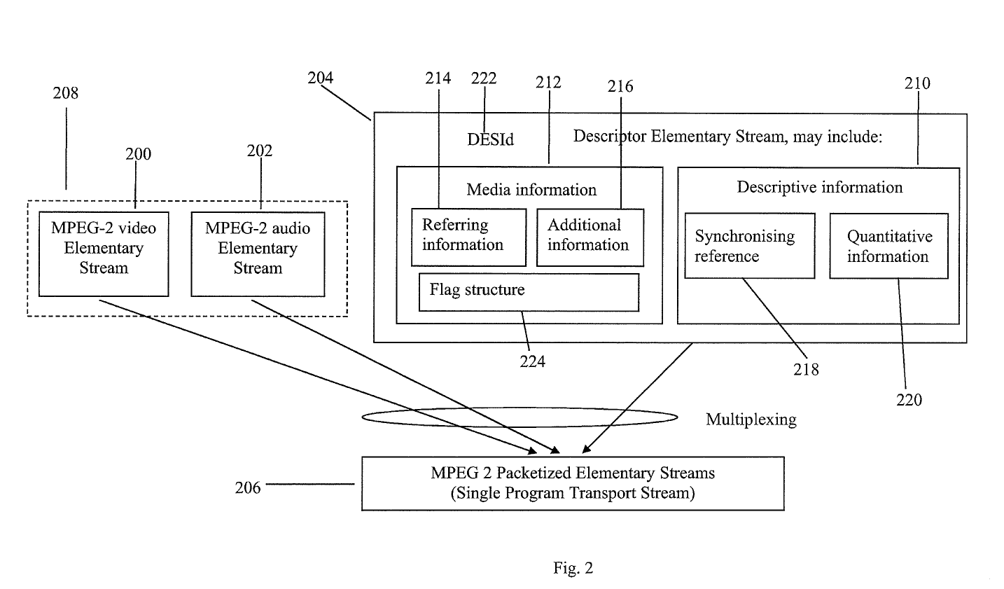

In FIG. 2 it is shown how the descriptor elementary stream 204 is multiplexed together with an MPEG video and an MPEG audio elementary stream into MPEG-2 packetised elementary streams, forming a Single Program Transport Stream. The descriptor elementary stream 204 is an additional elementary stream that is multiplexed into the transport stream (TS) and holds metadata that can be used to describe the content of the other elementary streams (the audio and video elementary streams).

FIGS. 3a-3c show the transport stream packet structure which may result with the inclusion of the descriptor elementary stream 204. Since the descriptor elementary stream 204 (which may be called a metadata stream) is just another elementary stream there is no special process needed for its multiplexing into the MPEG-2 Transport Stream for delivery purposes. In FIG. 6a it is shown how a transport stream 206 comprising descriptor elementary stream 204 and main media stream 208 may be transmitted (shown at 6:1, 6:2, 6:3 and 6:4) to a displaying device 608. The transport stream 206 may e.g. be transmitted from a party or node 602 that both produces the main media stream 208 and based on an analysis of the main media stream 208 creates the descriptor elementary stream 204, and creates a single transport stream 206 from these two streams. The step of producing the main media stream 208, the descriptor elementary stream 204 and the transport stream 206 may e.g. also be performed by a producing party or node 600 that transmits the transport stream 206 to a transmitting party or node 602 which then transmits the transport stream 206 to a receiving device 608. Different alternatives regarding whether the same or different party/ies or node/s create different parts of the transport stream 206 is something that the person skilled in the art may perceive and of course further alternatives are possible. For example the producing party or node 600 may create the main media stream 208 and a part of the descriptor elementary stream 204 which are then sent to the transmitting or transmitting and producing party or node 602. The party or node 602 then adds content to the descriptor elementary stream 204 to make it complete and creates and transmits the transport stream 206.

The transmitting, or transmitting and producing, party or node 602 transmits the transport stream 206. At the check and/or relay point 604 the status of the transport stream 206 may be checked. At the receiving device 606 the transport stream 206, and hence the descriptor elementary stream 204, is processed by the receiving device 606 which sends the resulting media content to the displaying device 608 where it is displayed.

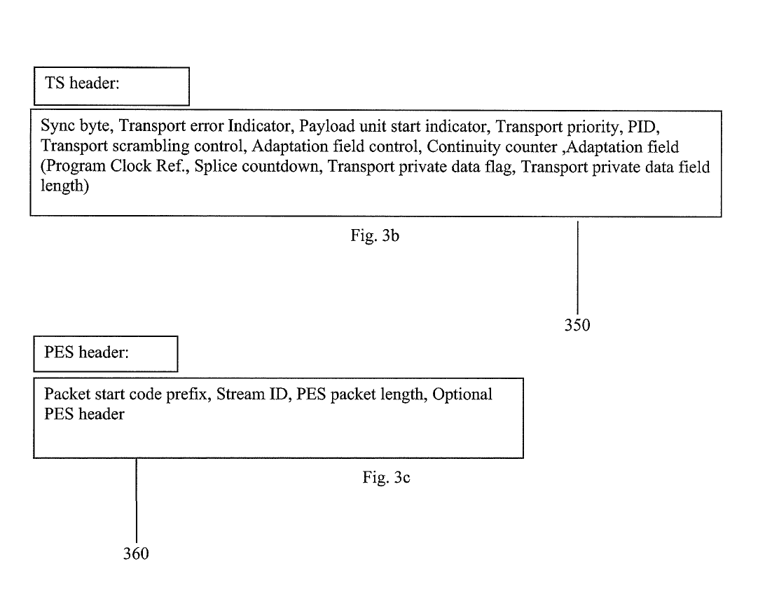

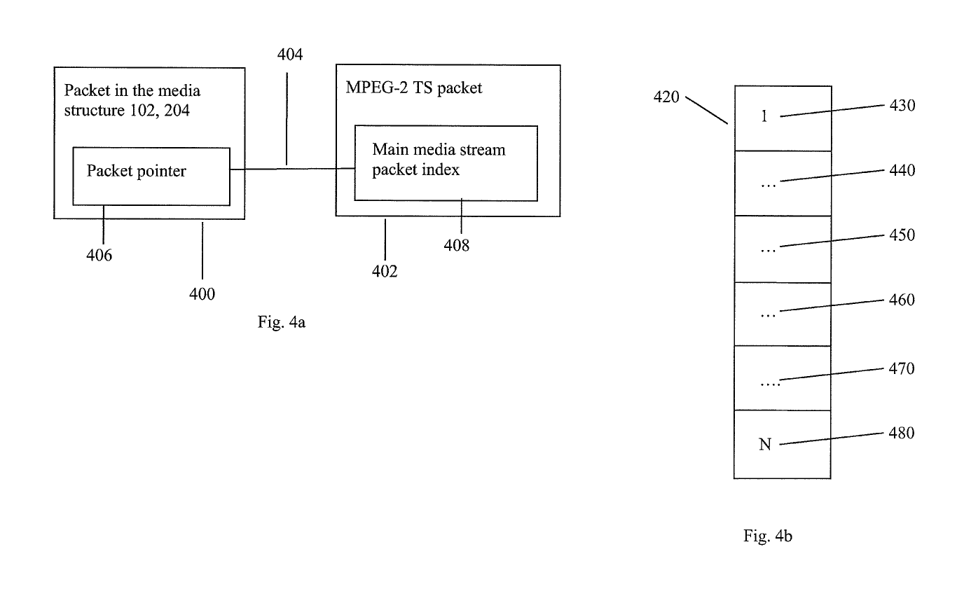

Another way of handling the descriptor elementary stream 204 is to transmit or deliver it separately (out of band) from the corresponding main media stream 208. In this case the receiving device 634, e.g. a decoder or a router, receives two separate streams, a first stream containing the main media stream 208 in any given format and a second stream containing the descriptor elementary stream 204 in a format that can be parsed by the receiving device 634 and synchronised to the main media stream 208 that is being received or processed by the receiving device 634. Advantageously the descriptor elementary stream 204 contains at least one field having a packet pointer 404 that points to a specific MPEG-2 TS packet so that information in the descriptor elementary stream 204 that refers to a part of the main media stream 208 contained in a specific MPEG-2 TS packet can be assigned to said specific MPEG-2 TS packet. The link between a packet in the descriptor elementary stream 204 and a MPEG-2 TS packet is illustrated in FIG. 4a.

In FIG. 6b it is shown how a descriptor elementary stream 204 may be transmitted separately from a main media stream 208. In this case these two streams may be transmitted by separate entities, parties or nodes, but may of course as well be transmitted by a single entity, party or node. It is also possible that two different transmitting entities, parties or nodes 624 and 628 transmit (shown at 6:18 and 6:22) two different descriptor elementary streams 204 which are linked to the same main media stream 208. In this case advantageously the two different descriptor elementary streams 204 have at least partly the same descriptive information 210. The receiving device 634 co-relates the at least one descriptor elementary stream 204 with the main media stream 208 and transmits (shown at 6:24) the resulting media content to the at least one displaying device 636a-d. The receiving device 634 may also check the status of the main media stream 208 using the information in the at least one descriptor elementary stream 204.

As indicated in FIG. 6b, the main media stream 208 may be created and transmitted by a single party or node 622, or one party or node 620 may create the main media stream 208 and transmit it (shown at 6:10) to a transmitting node 622 which then transmits (shown at 6:12, 6:14) the main media stream 208 to the receiving device 634. Also the creation or production of the descriptor elementary stream 204 may be divided between different parties or nodes. This is illustrated in FIG. 6b by the parties or nodes 624, 626, 628 and 630. For example may party or node 626 create a complete or a part of a descriptor elementary stream 204 which is then transmitted (shown at 6:16) to party or node 624 which then may add content to the descriptor elementary stream 204 to make it complete and transmit (shown at 6:18) it to the receiving device 634. In case the party or node 624 receives a complete descriptor elementary stream 204 the descriptor elementary stream 204 may simply be retransmitted by the party or node 624. The same is valid for the parties or nodes 628 and 630.

As stated in relation to FIG. 6a, different alternatives regarding whether the same or different party/ies or node/s create different parts of the main media stream 208 and/or of the descriptor elementary stream 204 is something that the person skilled in the art may perceive and of course further alternatives are possible than those illustrated here.

As indicated at 636a-d it is also possible that one receiving device 634 transmits (shown at 6:24) media content to more than one displaying device 636. This is also valid for the type of transmission illustrated in FIG. 6a.

The receiving device 634 has the functionality necessary to co-relate the two formats, i.e. functionality to interpret and/or execute the actions necessary to co-relate the first and second stream.

It is also possible to push the descriptor elementary stream 204 ahead of the main media stream 208, as in Video On Demand (VOD) assets, so that the receiving device 606, 634 receiving the main media stream 208 can pre-parse the data in the descriptor elementary stream 204 and prepare for the events that may occur while the main media stream 208 is consumed or processed by the receiving device 606, 634. Such events are triggered by or comprised in the descriptor elementary stream 204.

The approach of transmitting or delivering the descriptor elementary stream 204 separately from the main media stream 208 may be advantageous in scenarios where the main media stream 208 and the corresponding descriptor elementary stream 204 are delivered from separate sources, where it is not possible to multiplex the main media stream 208 and the descriptor elementary stream 204 or where it is beneficial to pre-push the descriptor elementary stream 204 to the receiving device 606, 634 servicing or processing the main media stream 208 and the descriptor elementary stream 204.

When transmitting or delivering the descriptor elementary stream 204 separately it is possible to co-relate the main media stream 208 and the descriptor elementary stream 204 at the point of the end user. This may e.g. be done in a decoder, set top box, or router. It is also possible to perform the co-relating at some point before the end user, e.g. at a relay point in the transmission network.

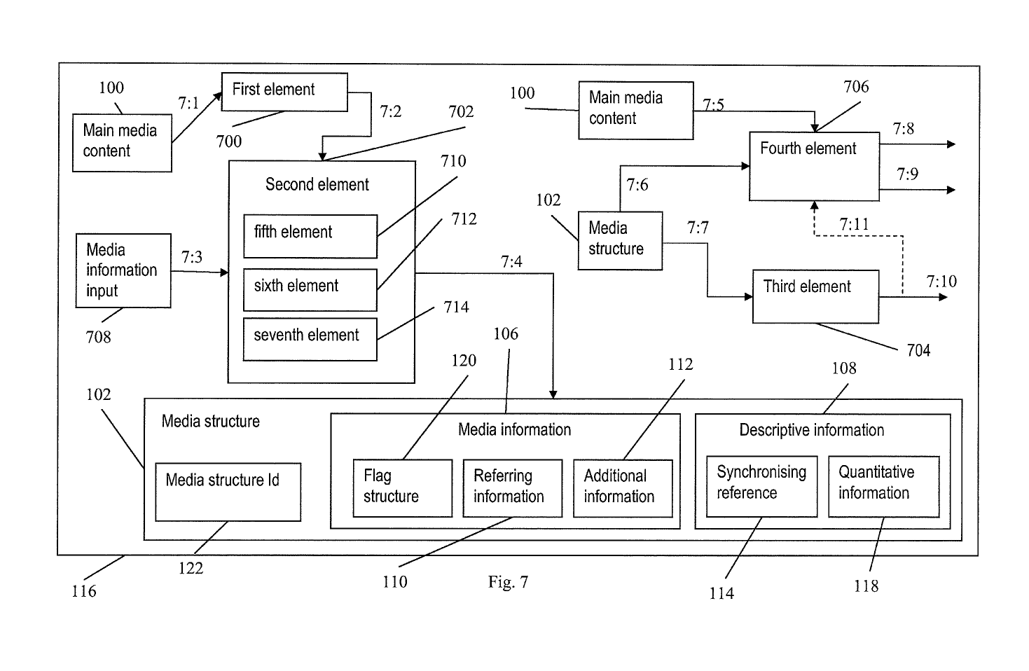

In FIG. 7 an arrangement according to the technique described herein is shown. The arrangement may comprise first to fourth elements 700, 702, 704 and 706. A first element 700 may receive the main media content 100, 208 as an input (shown at 7:1) and is among other things adapted to analyse said main media content 100, 208. The analysis result and/or the main media content 100, 208 itself may then be output from the first element 700 (shown at 7:2). A second element 702 may receive media information (shown as media information input 708) and the output from the first element 700 as inputs (shown at 7:3 respectively 7:2) and is among other things adapted to store descriptive information 108, 210 in the media structure 102, 204. The output from the second element 702 is shown at 7:4. The arrangement may also comprise a third element 704 which may receive the media structure 102 as an input (shown at 7:7) and may output (shown at 7:10) said media structure 102, 204 as a system stream in a MPEG-2 TS. The arrangement may further comprise a fourth element 706 which may receive the main media content 100, 208 (shown at 7:5) and the media structure 102, 204 (shown at 7:6) as inputs. The fourth element 706 may either process and output these inputs as two single transport streams (shown at 7:8) or the fourth element 706 may process and output these inputs as one single transport stream (shown at 7:9). The connection shown at 7:4 between the second element 702 and the media structure 102 is not only an output from the second element to the media structure 102, 204 but the second element 702 may also access the information in the media structure 102, 204 for analysing, changing or other processing of the information in the media structure 102, 204. As indicated at 7:11 the output from the third element 704 may also be an input to the fourth element 706. This may be an advantage if the fourth element 706 transmits transport stream/s of the MPEG-2 TS type.

The various functions that the second element 702 is adapted to perform may be realised in one single second element 702 but the second element 702 may also comprise a content adding fifth element 710, a linking sixth element 712 and an analysing seventh element 714 as sub-elements.

The different elements described herein may be implemented as electronic equipment where the different data input to or output from the elements may be in the form of electrical signals. The input and output signals may be transmitted by wireless transmission or by wire or may be in the form of data on a storage medium, where the storage medium e.g. may be a CD (Compact Disc), DVD, a hard disk, or a flash memory.

One advantage with the technique described herein is that it allows any operator, entity, party or node other than the provider of the main media stream 208, to associate media content to the main media stream 208 where it is relevant and without being dependent on the actual decoded main media stream 208.

Another advantage of the technique described herein is that the descriptor elementary stream 204 may be synchronised to the main media stream 208, that is to the audio and video media streams, by the existing synchronisation information embedded in the delivery mechanism, e.g. the MPEG-2 TS. In the case of a MPEG-2 TS, the existing synchronisation information is an identifier, a type of sequence number, hereafter called main media stream packet index 408, contained in each MPEG-2 TS packet. In each packet of the descriptor elementary stream 204 there may be a packet pointer 406 referring to a main media stream packet index 408 in a MPEG-2 TS packet comprising a part of the main media stream 208. In this way a link between the packets of the descriptor elementary stream 204 and the MPEG-2 packets of the main media stream 208 may be established. The link between a packet in the descriptor elementary stream 204 and a MPEG-2 TS packet of the main media stream 208 is illustrated in FIG. 4a. In FIG. 4a, reference sign 400 denotes a packet in the descriptor elementary stream 204, reference sign 406 denotes a packet pointer in a packet in the descriptor elementary stream 204, reference sign 402 denotes a MPEG-2 TS packet and reference sign 408 denotes a main media stream packet index in a MPEG-2 TS packet. In the case of in band transmission of the descriptor elementary stream 204, a packet 400 in the descriptor elementary stream 204 is the information contained in the system stream part of a MPEG-2 TS packet. The main media stream packet index 408 is then the identifier of a MPEG-2 TS packet, which comprises a part of the main media stream 208 and a part of the descriptor elementary stream 204. To have a packet pointer 406 in a packet of the descriptor elementary stream 204, the packet pointer 406 referring to the main media stream packet index 408 of a MPEG-2 TS packet, may be advantageous also in case of in band transmission of the descriptor elementary stream 204. This since it may be the case that the part of the descriptor elementary stream 204 comprised in a certain MPEG-2 TS packet, does refer to a part of the main media stream 208 comprised in another MPEG-2 TS packet.

If a list 420 of the packets in the main media stream 208, e.g. a list of the packets in a MPEG-2 TS, is included in the descriptor elementary stream 204 then devices handling the main media stream 208 and the descriptor elementary stream 204 can identify the completeness of the main media stream 208 without having to decrypt or decode the incoming packets in the main media stream 208. Such a list 420 may also be used to substitute packets in the main media stream 208 if needed. In FIG. 4b one example of a list 420 of the packets in the main media stream 208 is shown. For each packet in the main media stream 208 the list 420 contains the packet sequence number (shown as 1 to N in FIG. 4b), illustrated with reference signs 430-480.

The feature of transmitting or delivering the descriptor elementary stream 204 separate from the main media stream 208 may make it possible to use the technique described herein with any transport stream whether it supports encapsulation of a transport stream like the descriptor elementary stream 204 or not.

The concept of a descriptor elementary stream 204 may be used with media streams or media contents in a range of different forms. The main media stream 208 may be in the form of a streaming media content like a television broadcast or a broadcast from a streaming server. The main media stream 208 may also be present on a storage medium like e.g. a DVD, a hard disk or some other storage medium. In the latter case all media information 106, 212 may be comprised in the descriptor elementary stream 204, which also may be comprised on the storage medium. Or, in case that the device processing or playing the main media stream 208 and the descriptor elementary stream 204 is connected to some kind of network, additional information 112, 216 may be loaded from or activated in the network by means of referring information 110, 214, e.g. links or pointers, comprised in the descriptor elementary stream 204. What has been said about the descriptor elementary stream 204 is of course also valid for the general embodiment media structure 102, in so far applicable. What has been said about the main media stream 208 is of course also valid for the general embodiment main media content 100, in so far applicable.

Although particular embodiments have been disclosed herein in detail, this has been done by way of example for purposes of illustration only, and is not intended to be limiting with respect to the scope of the appended claims that follow. In particular, it is contemplated by the inventor that various substitutions, alterations, and modifications may be made to the invention without departing from the spirit and scope of the invention as defined by the claims.

### REFERENCE SIGNS

Main media content—100
Media structure—102
Link between main media stream and media structure—104
Media information—106
Descriptive information—108
Referring information—110
Additional information—112
Synchronising reference—114
Adaptable media content—116
Quantitative information—118
Flag structure—120
Media structure Id—122
MPEG-2 video elementary stream—200
MPEG-2 audio elementary stream—202
Descriptor elementary stream—204
MPEG-2 packetised elementary streams (single program transport stream)—206
Main media stream—208
Descriptive information—210
Media information—212
Referring information—214
Additional information—216
Synchronising reference—218
Quantitative information—220
Descriptor Elementary Stream (DES) Identification (DESId)—222
Flag structure—224
MPEG-2 Transport Stream (MPEG-2 TS)—300
MPEG-2 TS packet—302, 402
Slice (a number of frames)—304
Frame—306, 308
Block in a frame—310
Audio sample in an audio elementary stream (audio ES)—312
Transport stream (TS) header—314
PES (Packetised Elementary Stream) video header—316
PES (Packetised Elementary Stream) audio header—320
PES (Packetised Elementary Stream) system header—324
Payload ES-video—318
Payload ES-audio—322
Payload ES-descriptor elementary stream—326
Data fields in a TS header—350
Data fields in a PES header—360
Packet in the descriptor elementary stream—400
MPEG-2 TS packet—402, 302
Link between a packet of the descriptor elementary stream and a MPEG-2 TS packet—404
Packet pointer in a packet of the descriptor elementary stream—406
Packet sequence number in a MPEG-2 TS packet—408
Different method steps relating to forming the media structure—500, 502, 510, 512, 514
Producing party or node of transport stream 206—600,
Transmitting or transmitting and producing party or node of transport stream 206—602
Check and/or relay point—604, 632
Receiving device—606, 634
Displaying device—608, 636a-d
Producing party or node of main media stream 208—620
Transmitting, or transmitting and producing, party or node of main media stream 208—622
First transmitting, or transmitting and producing, party or node of descriptor elementary stream 204—624
First producing party or node of descriptor elementary stream 204—626
Second transmitting, or transmitting and producing, party or node of descriptor elementary stream 204—628
Second producing party or node of descriptor elementary stream 204—630
System illustrating transmission of main media stream 208 and descriptor elementary stream 204 as one single transport stream—650
System illustrating transmission of main media stream 208 and descriptor elementary stream 204 as separate transport streams—670
First element—700
Second element—702
Third element—704
Fourth element—706
Media information input—708
Content adding fifth element—710
Linking sixth element—712
Analysing seventh element—714

1. A method, executed in a node for transmitting, processing and/or producing media content, of providing a media structure for customising a main media content, said method comprising the steps of:
analysing said main media content regarding events of interest in said main media content, and thereby identifying at least one event of interest,
based on the analysis performed in step a., storing descriptive information, relating to said main media content, in said media structure.

2. The method according to claim 1, comprising the step of:
adding at least one synchronising reference, referring to said main media content, to said descriptive information.

3. The method according to claim 1, comprising the step of:
adapting said media structure for containing media information, wherein such media information in particular may be: media content or references to media sources.

4. The method according to claim 3, comprising the step of:
adding media information to said media structure, and wherein said media information comprises referring information and/or additional information.

5. The method according to claim 1, comprising the step of:
defining said media structure as a system stream in a MPEG-2 Transport Stream.

6. The method according to claim 2, comprising the step of:
providing said at least one synchronising reference at least one of the following levels: a transport stream level, a transport stream packet level, a time stamp level, a slice level, a frame level, a macro block level, an object level.

7. The method according to claim 6, comprising the step of:
adding to said referring information, at least one of the following: a pointer or link to the Internet, a pointer or link to a media source, a pointer or link to a particular action to be executed by a receiving device, data to be consumed by another media content than the main media content.

8. The method according to claim 3, comprising the step of:
adding to said media information, at least one of the following:
advertisement placement, content location functions, channel switching, content splicing, content related interactivity, voting services, marketing information, EPG (Electronic Program Guide), product placement, Picture in Picture services.

9. The method according to claim 3, comprising the step of:
linking said media information to said descriptive information.

10. The method according to claim 4, comprising the step of:
linking said media information to said at least one synchronising reference.

11. The method according to claim 1, comprising the steps of:
analysing said main media content regarding events of interest in said main media content, and identifying at least one event of interest,
based on said at least one event of interest identified in step a., creating at least one synchronising reference and storing said at least one synchronising reference in said media structure, said at least one synchronising reference referring to said at least one event of interest.

12. The method according to claim 1, comprising the steps of:
analysing said descriptive information,
adding media information to said media structure based on the analysis performed in step a.

13. The method according to claim 1, comprising the step of:
adding quantitative information relating to said main media content, to said descriptive information, for enabling validation of the status of said main media content when transmitting said main media content and said media structure in a network or system, by comparing the content of said main media content with said quantitative information.

14. The method according to claim 13, comprising the step of:
defining said main media content as a packetised stream and adding a list of the packets of said main media content to said quantitative information, said list comprising packet sequence numbers (408, 430-480).

15. The method according to claim 1, comprising the step of:
transmitting said main media content and said media structure as separate transport streams, for example as MPEG-2 Transport Streams.

16. The method according to claim 1, comprising the step of:
transmitting said main media content and said media structure as one single transport stream, for example as one single MPEG-2 Transport Stream.

17. An arrangement in a node for transmitting, processing and/or producing media content, for providing a media structure for customising a main media content, wherein the arrangement comprises:
a first element adapted to analyse said main media content regarding events of interest in said main media content, and to thereby identify at least one such event of interest,
a second element connected to receive at least one analysis result from said first element, and adapted to store descriptive information, relating to said main media content, in said media structure, based at least partly on said at least one event of interest.

18. The arrangement according to claim 17, wherein said second element is adapted to add at least one synchronising reference, referring to said main media content, to said descriptive information.

19. The arrangement according to claim 17, wherein said second element is adapted to adapt said media structure for containing media information, wherein such media information in particular may be: media content or references to media sources.

20. The arrangement according to claim 19, wherein said second element is adapted to add media information to said media structure, and wherein said media information comprises referring information and/or additional information.

21. The arrangement according to claim 17, comprising:
a third element for defining said media structure as a system stream in a MPEG-2 Transport Stream.

22. The arrangement according to claim 18, wherein said second element is adapted to provide said at least one synchronising reference at least one of the following levels: a transport stream level, a transport stream packet level, a time stamp level, a slice level, a frame level, a macro block level, an object level.

23. The arrangement according to claim 20, wherein said second element is adapted to add to said referring information, at least one of the following: a pointer or link to the Internet, a pointer or link to a media source, a pointer or link to a particular action to be executed by a receiving device, data to be consumed by another media content than the main media content.

24. The arrangement according to claim 19, wherein said second element is adapted to add to said media information, at least one of the following: advertisement placement, content location functions, channel switching, content splicing, content related interactivity, voting services, marketing information, EPG (Electronic Program Guide), product placement, Picture in Picture services.

25. The arrangement according to claim 19, wherein said second element is adapted to link said media information to said descriptive information.

26. The arrangement according to claim 20, wherein said second element is adapted to link said media information to said at least one synchronising reference.

27. The arrangement according to claim 17, wherein said second element is adapted to create at least one synchronising reference and to store said at least one synchronising reference in said media structure, based at least partly on said at least one event of interest, wherein said at least one synchronising reference is referring to said at least one event of interest.

28. The arrangement according to claim 17, wherein said second element is adapted to analyse said descriptive information, and to add media information to said media structure, wherein said second element is adapted to add media information to said media structure taking into account an analysis of said descriptive information.

29. The arrangement according to claim 17, wherein said second element is adapted to add quantitative information relating to said main media content, to said descriptive information, for enabling validation of the status of said main media content when transmitting said main media content and said media structure in a network or system, by comparing the content of said main media content with said quantitative information.

30. The arrangement according to claim 29, wherein said second element is adapted to define said main media content as a packetised stream and to add a list of the packets of said main media content to said quantitative information, said list comprising at least one main media content packet index.

31. The arrangement according to claim 17, comprising a fourth element adapted to transmit said main media content and said media structure.

32. The arrangement according to claim 31, wherein said fourth element is adapted to transmit said main media content and said media structure as separate transport streams, for example as MPEG-2 Transport Streams.

33. The arrangement according to claim 31, wherein said fourth element is adapted to transmit said main media content and said media structure as one single transport stream, for example as one single MPEG-2 Transport Stream.
